(19) United States
(12) Patent Application Publication
(10) Pub. No.: US 2024/0413438 A1
(43) Pub. Date: Dec. 12, 2024

(54) Battery Cell and Battery Module Comprising the Same

(71) Applicant: LG Energy Solution, Ltd., Seoul (KR)

(72) Inventors: Min Yong Jung, Daejeon (KR); Hee Gyu Kim, Daejeon (KR); Bum Choi, Daejeon (KR); Jong Yoon Keum, Daejeon (KR); Jae Heon Chung, Daejeon (KR)

(73) Assignee: LG Energy Solution, Ltd., Seoul (KR)

(21) Appl. No.: 18/699,805

(22) PCT Filed: Mar. 31, 2023
(86) PCT No.: PCT/KR2023/004356

§ 371 Date: Apr. 9, 2024

(30) Foreign Application Priority Data
Apr. 1, 2022 (KR) 10-2022-0041076

(51) Int. Cl. H01M 50/145; H01M 10/613; H01M 10/6567; H01M 50/119; H01M 50/124; H01M 50/24

(52) U.S. Cl. CPC H01M 50/145; H01M 10/613; H01M 10/6567; H01M 50/119; H01M 50/1245; H01M 50/24

(57) ABSTRACT

The present disclosure relates to a battery cell and a battery module comprising the same, and relates, particularly, to a direct water-cooling battery cell and a direct water-cooling battery module comprising the same. According to the present disclosure, the corrosion resistance of the battery cell can be improved by using a sacrificial metal having a higher metal ionization tendency than that of a battery cell case, and the heat of the battery cell can be cooled by using general cooling water for vehicles.

### CROSS-REFERENCE TO RELATED APPLICATIONS

This application is a national phase entry under 35 U.S.C. § 371 of International Application No. PCT/KR2023/004356 filed on Mar. 31, 2023, which claims the benefit of priority based on Korean Patent Application No. 10-2022-00410076 dated Apr. 1, 2022, the disclosure of which are incorporated herein by reference in their entireties.

### TECHNICAL FIELD

The present disclosure is a battery cell and a battery module comprising the same, which relates, particularly, to a direct water-cooling battery cell and a direct water-cooling battery module comprising the same, and relates, in detail, to a direct water-cooling battery cell capable of improving corrosion resistance of the battery cell by using a sacrificial metal having a higher metal ionization tendency than that of a battery cell case, and a direct water-cooling battery module comprising the same.

### Background Art

Batteries used in eco-friendly vehicles generate a large amount of heat because high power is required, and in order to improve battery performance and lifespan, it is very important to efficiently discharge heat generated from the battery, thereby preventing the batteries from overheating.

Conventionally, as a cooling system for dissipating heat from a battery, a direct air-cooling method, an indirect water-cooling method, or a direct water-cooling method is known.

The direct water-cooling method is a method in which battery cells are directly immersed in cooling water, and heat from the battery cells is directly discharged into the cooling water.

FIG. 1 is a schematic configuration diagram of a conventional battery module (10).

Referring to FIG. 1, a direct water-cooling type battery module (10) consists of a cell frame (11) and a plurality of battery cells (12). The plurality of battery cells (12) is spaced apart from each other in the cell frame (11). The cell frame (11) is provided so that cooling water can flow.

Generally, in the battery cell (12), an exterior case accommodating internal electrodes is made of nickel-plated iron. Accordingly, when the battery cell (12) is directly impregnated with cooling water, it is vulnerable to corrosion due to the material characteristics of the exterior case. In addition, there is a problem that the exterior case is polar, and also has vulnerable electrical insulation.

In order to prevent corrosion of the battery cell (12) in the battery module (10) of the conventional direct water-cooling method, insulating oil or special cooling water (M) (e.g., 3M's NOVEC) is used.

However, the insulating oil has a problem of being vulnerable to fire, and the special cooling water such as 3M's NOVEC is excellent as a coolant for battery cells in that it is non-polar and has corrosion resistance, but it is expensive, whereby there is a problem of increasing the manufacturing cost of the battery module.

Also, when an antirust liquid is applied to the exterior case of the battery cell (12) in order to prevent corrosion of the battery cell (12) as in the conventional art, a post-treatment process of covering the exterior case of the battery cell (12) using a non-woven fabric is required to maintain the antirust liquid.

In addition, even if the antirust liquid is applied to the exterior case of the battery cell (12), the antirust agent flows down from the exterior case of the battery cell due to surface tension, whereby there is a problem that the antirust agent is not evenly applied to the exterior case.

### DISCLOSURE

### Technical Problem

The present disclosure is intended to provide a direct water-cooling battery cell capable of improving corrosion resistance of a battery cell by using a sacrificial metal having a higher metal ionization tendency than that of a battery cell case, and a direct water-cooling battery module comprising the same.

### Technical Solution

A battery cell for direct water cooling according to one example of the present disclosure comprises an electrode assembly, a case accommodating the electrode assembly, a first plating layer formed on an outer surface of the case, a scratch part formed by removing a partial region of the first plating layer, and a sacrificial metal part provided to surround the scratch part, and formed of a material having a higher metal ionization tendency than that of the first plating layer.

Also, the scratch part may be formed by removing a partial region of the first plating layer along the thickness direction of the first plating layer.

In addition, the scratch part may be formed to a partial region of the first plating layer along the thickness direction of the first plating layer and an outer circumferential surface of the case facing the partial region. At this instance, the sacrificial metal part may be coupled to the outer circumferential surface of the case. In addition, the sacrificial metal part may be coupled to the outer circumferential surface of the case by a laser brazing method. Specifically, the sacrificial metal part may be coupled to the outer circumferential surface of the case while a region passing through a partial region of the first plating layer is melted by a laser beam.

Furthermore, the sacrificial metal part may comprise one or more selected from the group consisting of aluminum, magnesium, zinc, an aluminum alloy, a magnesium alloy, and a zinc alloy.

Also, the scratch part may be provided in a band shape along the circumferential direction of the case.

In addition, the scratch part may comprise a first scratch part located at the upper end of the case and a second scratch part located at the lower end of the case. At this instance, the sacrificial metal part may surround the first and second scratch parts so that the first and second scratch parts are not exposed to the outside. At this instance, the sacrificial metal part may be coupled to the first and second scratch parts, respectively. Furthermore, the sacrificial metal part may be coupled to the first and second scratch parts, respectively, while being melted by the laser beam.

Also, the first plating layer may comprise a nickel-plating layer.

In addition, the scratch part may be formed while a partial region of the first plating layer is peeled off by a laser, or a partial region of the first plating layer is peeled off by etching treatment.

The battery cell may comprise a cell sheet comprising a polymer film and provided to surround the sacrificial metal part.

Also, the cell sheet may surround the outer surface of the case so that one end of the cell sheet and the other end of the cell sheet overlap along the circumferential direction of the case.

In addition, the battery module related to one example of the present disclosure comprises the plurality of battery cells, a cell frame provided so that the plurality of battery cells is disposed apart from each other, and cooling water allows to flow between the plurality of battery cells, and a cooling water supply part for supplying cooling water into the cell frame.

Furthermore, the battery module may comprise a waterproof layer provided inside the cell frame and provided to cover the side end of the upper surface and the side end of the lower surface of the case, respectively., wherein the waterproof layer may comprise a waterproof adhesive or a potting resin.

In addition, the cooling water supply part may be provided to supply cooling water that is not insulated.

### Advantageous Effects

As described above, the direct water-cooling battery cell related to at least one example of the present disclosure, and the direct water-cooling battery module comprising the same have the following effects.

The corrosion resistance of the battery cell can be improved by using a sacrificial metal having a higher metal ionization tendency than those of the case and the first plating layer of the battery cell. In addition, the heat of the battery cell can be cooled by using a low-cost general cooling water for vehicles that is not insulated.

In addition, the heat resistance, waterproofness, and insulation properties of the battery cell can be improved through the cell sheet surrounding the sacrificial metal part.

### DESCRIPTION OF DRAWINGS

FIG. 1 is a schematic configuration diagram of a conventional battery module.

FIG. 2 is a schematic diagram showing a battery module for direct water cooling according to one example of the present disclosure.

FIGS. 3 and 4 are front views showing a scratch part of a battery cell according to one example of the present disclosure.

FIG. 5 is a diagram for explaining a method of combining a scratch part and a sacrificial metal part.

FIG. 6 is a perspective diagram schematically showing a battery cell in a state where a sacrificial metal part is coupled on a first plating layer.

FIG. 7 is a perspective diagram schematically showing a battery cell disposed in a battery module.

FIGS. 8 and 9 are cross-sectional diagrams schematically showing a state cut along the line X-X of FIG. 7.

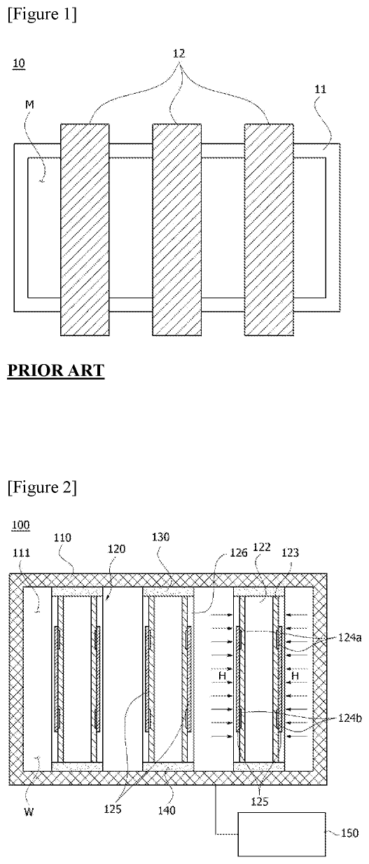

### MODE FOR DISCLOSURE

Hereinafter, a direct water-cooling battery cell (hereinafter, also referred to as a ‘battery cell’) according to one example of the present disclosure, and a direct water-cooling battery module (hereinafter, also referred to as a ‘battery module’) comprising the same will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

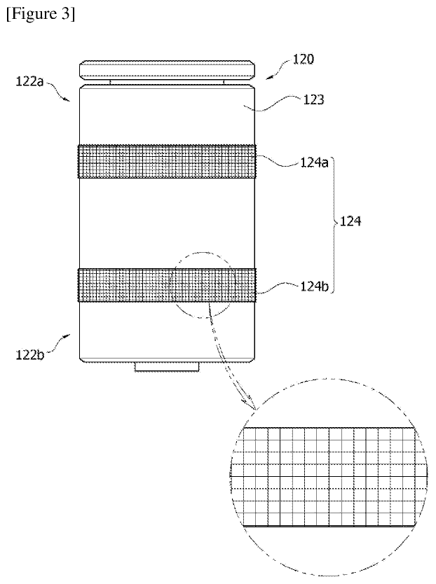

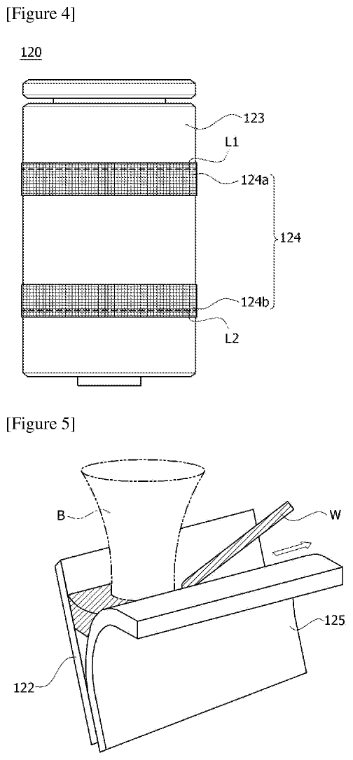

FIG. 2 is a schematic diagram showing a battery module (100) for direct water cooling according to one example of the present disclosure, and FIGS. 3 and 4 are front views showing a scratch part of a battery cell (120) according to one example of the present disclosure.

Referring to FIG. 2, the battery module (100) according to one example of the present disclosure comprises a plurality of battery cells (120), a cell frame (110) accommodating the plurality of battery cells, and a cooling water supply part (150). In addition, the battery module (100) comprises a plurality of battery cells (120), a cell frame (110) provided so that the plurality of battery cells (120) is disposed apart from each other, and cooling water (W) allows to flow between the plurality of battery cells (120), and a cooling water supply part (150) for supplying cooling water into the cell frame (110).

In addition, the cell frame (110) has a predetermined space part (111) therein, and is provided in a structure in which cooling water (W) can flow within the space part (111). The cooling water (W) may be supplied to the inner space part (111) of the cell frame (110), and then discharged to the outside of the cell frame (110). To this end, the battery module (100) may comprise a cooling water discharge part for discharging the cooling water (W) to the outside of the cell frame (110). The cooling water supply part (150) may comprise a cooling water storage tank and a pump. In addition, the cooling water supply part (150) may be provided to supply cooling water (W) that is not insulated. The general cooling water (W) may be cooling water generally used in vehicles.

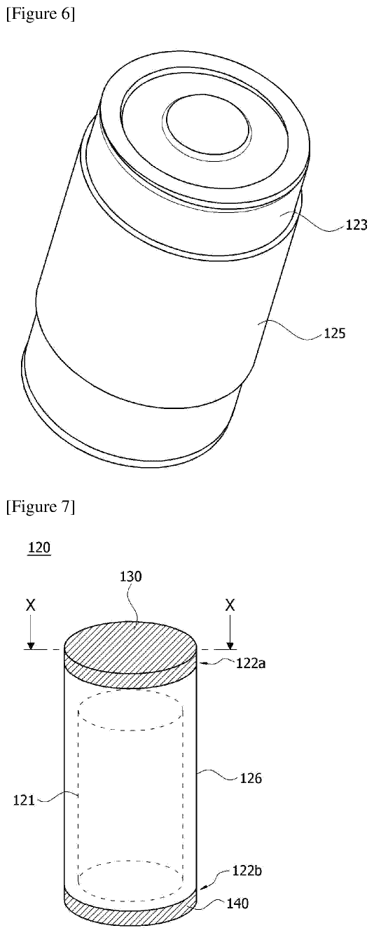

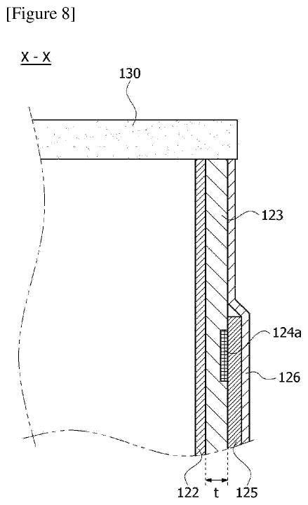

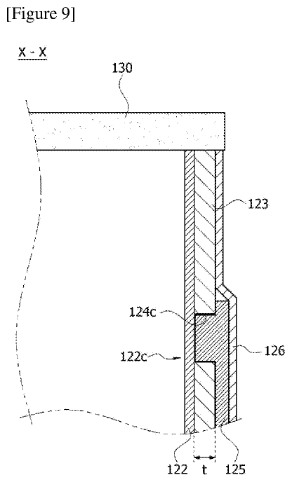

FIG. 5 is a diagram for explaining a method of combining a scratch part and a sacrificial metal part, FIG. 6 is a perspective diagram schematically showing a battery cell in a state where a sacrificial metal part is coupled on a first plating layer, FIG. 7 is a perspective diagram schematically showing a battery cell disposed in a battery module, and FIGS. 8 and 9 are cross-sectional diagrams schematically showing a state cut along the line X-X of FIG. 7.

The battery cell (120) according to one example of the present disclosure comprises an electrode assembly (121), a case (122), a first plating layer (123), a scratch part (124), and a sacrificial metal part (125). In addition, the battery cell (120) may comprise a cell sheet (126) comprising a polymer film and provided to surround the sacrificial metal part (125).

The battery cell (120) comprises an electrode assembly (121), a case (122) accommodating the electrode assembly (121), a first plating layer (123) formed on an outer circumferential surface of the case (122), a scratch part (124: 124a, 124b) formed by removing a partial region of the first plating layer (123), and a sacrificial metal part (125) provided to surround the scratch part (124) and formed of a material having a higher metal ionization tendency than that of the first plating layer (123).

Referring to FIG. 2, when the direct water-cooling battery cell (120) is immersed in the cooling water (W), the moisture (H) may be transferred to the sacrificial metal part (125). At this time, since the metal ionization reaction to moisture (H) in the sacrificial metal part (125) is greater than the metal ionization reaction to moisture in the case (122), the corrosion resistance of the case (210) can be improved.

As one example, the sacrificial metal part (125) may also be plated on the first plating layer (123), and may also be welded on the first plating layer (123).

Referring to FIG. 2, when the battery module (100) uses general cooling water (W), the moisture (H) penetrates through the corroded portion on the surface of the battery cell (120), so that the power of the battery cell is energized with the general cooling water, whereby there may be a problem that the battery module (100) is damaged.

Referring to FIG. 2, when the direct water-cooling battery cell (120) is immersed in the cooling water (W), the moisture (H) of the cooling water (W) is subjected to ionization reaction with the sacrificial metal part (212) due to the difference in metal ionization reaction between the case (122) and the sacrificial metal part (125), and as a result, the metal ionization reaction of the case (122) is suppressed, whereby the direct water-cooling battery cell (120) can prevent corrosion of the case (122).

The electrode assembly (121) is accommodated in the case (122), and comprises a positive electrode, a negative electrode, and a separator disposed between the positive electrode and the negative electrode. The electrode and the separator may constitute an integrated electrode assembly (121). For example, the electrode assembly (121) may be a jelly-roll type electrode assembly in which sheet-type positive and negative electrodes are wound in a state where a separator is interposed therebetween, a stack type electrode assembly in which pluralities of positive and negative electrodes are sequentially stacked in a state where a separator is interposed therebetween, or a stack/folding type electrode assembly in which unit cells obtained by stacking positive and negative electrodes in predetermined units in a state where a separator is interposed therebetween are sequentially wound in a state where they are positioned on a separation film.

In addition, the case (122) serves to accommodate the electrode assembly (121), and to protect the battery cell (120) from external impacts. The case (122) may be cylindrical, pouch, or angular, and for example, the case (122) may be cylindrical. In particular, the electrode assembly (121) may be a rolled jelly-roll type electrode assembly, the case (122) may be a cylindrical case, and the direct water-cooling battery cell (120) may be a cylindrical battery cell.

Also, the case (122) may be formed of a metal material, and the case (122) may be formed of one or more selected from the group consisting of steel or stainless steel.

In addition, the surface of the case (122) may be nickel (Ni)-plated. That is, the first plating layer (123) may comprise a nickel-plating layer.

Meanwhile, the nickel-plating layer has little discoloration, excellent rust resistance force, and excellent corrosion resistance and wear resistance. However, due to material characteristics, the nickel-plating layer may be corroded when immersed in cooling water, and as the corrosion progresses, polarity is generated and simultaneously insulation properties are deteriorated.

Meanwhile, when the sacrificial metal part (125) is provided on the first plating layer (123), the first plating layer (123) may be a factor that hinders the movement of electrons between the sacrificial metal part (125) and the case (122).

The scratch part (124) is formed on the first plating layer (123), and then the sacrificial metal part (125) is coupled to the scratch part (124), whereby electron movement between the sacrificial metal part (125) and the case (122) can be made smoothly.

Referring to FIGS. 3 and 8, the scratch part (124: 124a) may be formed by removing a partial region of the first plating layer (123) along the thickness direction (t) of the first plating layer (123). That is, the scratch part may be formed by scraping the first plating layer (123) by a predetermined thickness, and the region where the scratch part (124) is formed on the first plating layer (123) has a thinner thickness than the surrounding region.

In addition, the scratch part (124) may be formed, as a partial region of the first plating layer (123) is peeled off by a laser or a partial region of the first plating layer (123) is peeled off by etching treatment. That is, the scratch part (124) may also be formed by scratching the first plating layer (123) by a laser, and the scratch part (124) may also be formed by etching the first plating layer (123). The etching treatment method is based on a chemical corrosion method.

Referring to FIGS. 3 and 9, the scratch part (124: 124c) may be formed to a partial region of the first plating layer (123) along the thickness direction (t) of the first plating layer (123) and the outer circumferential surface of the case facing the partial region. That is, the scratch part (124c) may be formed by scratching the first plating layer (123) to pass through the first plating layer (123) along the thickness direction (t), and then scratching the exposed outer circumferential surface (122c) of the case. At this instance, the sacrificial metal part (125) may be coupled to the outer circumferential surface (122c) of the case (122). In this structure, the sacrificial metal part (125) may be directly coupled to the outer circumferential surface (122c) of the case (122) by passing through the first plating layer (123).

Referring to FIGS. 3 and 4, the scratch treatment is performed on the first plating layer (123), whereby a plurality of depressions may be formed in the scratched region. For example, the depressions may also be provided in a lattice shape. In addition, the scratch part (124) may be provided in a band shape along the circumferential direction of the case (122).

In addition, a plurality of scratch parts (124) may be provided in different regions of the first plating layer (123). For example, the scratch part (124) may comprise a first scratch part (124a) located on the upper end (122a) of the case (122) and a second scratch part (124b) located on the lower end (122b) of the case (122).

Referring to FIGS. 5 and 6, the sacrificial metal part (125) may be disposed to surround the outer surface of the case (122), and may be disposed on the first plating layer (123) to surround the first plating layer (123).

In addition, the sacrificial metal part (125) may be formed of a material having a higher metal ionization reaction than that of the case (122). The sacrificial metal part (125) may comprise one or more selected from the group consisting of aluminum, magnesium, zinc, an aluminum alloy, a magnesium alloy, and a zinc alloy.

The sacrificial metal part (125) is provided to surround the scratch part (124) so that the scratch part (124) is not exposed to the outside. As one example, the sacrificial metal part (125) may be provided to surround the first and second scratch parts (124a 124b) so that the first and second scratch parts (124a 124b) are not exposed to the outside.

In this document, the scratch part (124: 124a, 124b) may comprise a region where a partial thickness of the first plating layer (123) is scratched, and a region where the first plating layer (123) is passed through and scratched to the outer circumferential surface of the case.

At this time, the sacrificial metal part (125) may be coupled to the scratch part (124), and when a plurality of scratch parts is provided, the sacrificial metal part (125) may be coupled to the first and second scratch parts (124a, 124b), respectively.

In addition, each of the first and second scratch parts (124a, 124b) may be provided in a band shape along the circumferential direction of the case (122). Furthermore, the sacrificial metal part (125) may be provided in a band shape along the circumferential direction of the case (122).

Referring to FIGS. 4 and 6, the upper end of the sacrificial metal part (125) may cover the first scratch part (124a), and the lower end of the sacrificial metal part (125) may cover the second scratch part (124b). As such, the sacrificial metal part (125) may be provided in a band shape covering the scratch part (124) and coupled to the first plating layer (123)(121) along the circumference of the case (122).

Referring to FIG. 5, the sacrificial metal part (125) may be coupled to the scratch part along virtual bonding lines (L1, L2) extending along the circumferential direction of the case (122) by a laser brazing method. In an example in which the scratch part is formed to the outer circumferential surface of the case by passing through the first plating layer, FIG. 5 is a diagram explaining a process in which the sacrificial metal part is coupled to the outer circumferential surface of the case (122) (see FIG. 9).

Referring to FIG. 5, the sacrificial metal part (125) may be coupled to the outer circumferential surface of the case (122) while a wire (W) is melted by the laser beam (B).

Referring to FIGS. 4 to 6, the upper end of the sacrificial metal part (125) may be coupled to the first scratch part (124a) while the wire (W) is melted by the laser beam along the first bonding line (L1). Here, the first bonding line (L1) means a virtual line where the wire (W) is bonded in the first scratch part (124a).

The lower end of the sacrificial metal part (125) may be coupled to the second scratch part (124b) while the wire (W) is melted by the laser beam along the second bonding line (L2). Here, the second bonding line (L2) means a virtual line where the wire (W) is bonded in the second scratch part (124b).

That is, the sacrificial metal part (125) may also be provided to integrally surround the upper and lower ends of the case (122), and the sacrificial metal part (125) may also be provided at the upper end (122a) and the lower end (122b) of the case (122), respectively.

In addition, the sacrificial metal part (125) may also be formed in a band shape to surround a partial region of the case (122) in the circumferential direction. Furthermore, the sacrificial metal part (125) may surround the case (122) along the circumferential direction of the case (122) in a ring shape.

Referring to FIGS. 7 to 9, the battery cell (120) may comprise a cell sheet (126) comprising a polymer film and provided to surround the sacrificial metal part (125).

The cell sheet (126) may surround the outer surface of the case (122) so that one end of the cell sheet (126) and the other end of the cell sheet (126) overlap along the circumferential direction of the case (122).

In addition, the cell sheet (126) may be in close contact with the sacrificial metal part (125) while being thermally contracted.

The cell sheet (126) may be formed of a heat-shrinkable polymer material. The heat-shrinkable polymer material may comprise one or more selected from the group consisting of polyvinyl chloride (PVC), polypropylene (PP), and polyethylene terephthalate (PET).

Meanwhile, the battery module (100) may comprise a waterproof layer (130, 140) provided inside the cell frame (110), and provided to cover the upper end (122a) and the lower end (122b) of the case (122) of the battery cell (120), respectively.

The waterproof layer (130, 140) performs a function of preventing moisture from permeating into the case (122) and fixing the battery cell (120) to the cell frame (110).

An upper waterproof layer (130) may be provided on the upper end (122a) of the case (122), and a lower waterproof layer (140) may be provided on the lower end (122b) of the case (122). As one example, the waterproof layer (130, 140) may be provided to surround a partial region of the sacrificial metal part (125). In addition, the upper end (122a) side and the lower end (122b) side of the battery cell (120) may be fixed to the inner surface of the cell frame (110) through the waterproof layer (130, 140), respectively.

The waterproof layer (130, 140) may comprise a waterproof adhesive or a potting resin, and the potting resin may be any one of a silicone-based resin, a urethane-based resin, and an epoxy-based resin.

The preferred examples of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to the direct water-cooling battery cell related to at least one example of the present disclosure, and the direct water-cooling battery module comprising the same, the corrosion resistance of the battery cell can be improved by using a sacrificial metal having a higher metal ionization tendency than those of the case and the first plating layer of the battery cell.

1. A battery cell comprising:
an electrode assembly;
a case accommodating the electrode assembly:
a first plating layer formed on an outer surface of the case:
a scratch part formed by removing a partial region of the first plating layer; and
a sacrificial metal part provided to surround the scratch part, and formed of a material having a higher metal ionization tendency than that of the first plating layer.

2. The battery cell according to claim 1, wherein
in the scratch part, a partial region of the first plating layer is removed along a thickness direction of the first plating layer.

3. The battery cell according to claim 2, wherein
the scratch part is formed to a partial region of the first plating layer along the thickness direction of the first plating layer and an outer circumferential surface of the case facing the partial region.

4. The battery cell according to claim 3, wherein
the sacrificial metal part is coupled to the outer circumferential surface of the case.

5. The battery cell according to claim 1, wherein
the sacrificial metal part comprises at least one of an aluminum, magnesium, zinc, an aluminum alloy, a magnesium alloy, or a zinc alloy.

6. The battery cell according to claim 1, wherein
the scratch part is provided in a band shape along a circumferential direction of the case.

7. The battery cell according to claim 1, wherein
the scratch part comprises a first scratch part located at an upper end of the case and a second scratch part located at a lower end of the case, and
the sacrificial metal part surrounds the first and second scratch parts so that the first and second scratch parts are not exposed to the outside.

8. The battery cell according to claim 7, wherein
the sacrificial metal part is coupled to the first and second scratch parts, respectively.

9. The battery cell according to claim 1, wherein
the first plating layer comprises a nickel-plating layer.

10. The battery cell according to claim 1, wherein
in the scratch part, a partial region of the first plating layer is arranged to be peeled off by a laser, or a partial region of the first plating layer is arranged to be peeled off by etching treatment.

11. The battery cell according to claim 1, comprising
a cell sheet comprising a polymer film, and provided to surround the sacrificial metal part.

12. The battery cell according to claim 11, wherein
the cell sheet surrounds the outer surface of the case so that one end of the cell sheet and the other end of the cell sheet overlap along the circumferential direction of the case.

13. A battery module comprising:
a plurality of battery cells according to claim 1;
a cell frame provided so that the plurality of battery cells is disposed apart from each other, and cooling water is configured to flow between the plurality of battery cells; and
a cooling water supply part for supplying cooling water into the cell frame.

14. The battery module according to claim 13, wherein
the battery module comprises a waterproof layer provided inside the cell frame and provided to cover a side end of an upper surface and a side end of a lower surface of the case, respectively, where the waterproof layer comprises a waterproof adhesive or a potting resin.

15. The battery module according to claim 13, wherein
the cooling water supply part is provided to supply cooling water that is not insulated.
